(19) United States
(12) Patent Application Publication
(10) Pub. No.: US 2022/0134567 A1
(43) Pub. Date: May 5, 2022

(54) ROBOT SYSTEM, ROBOT CONTROL DEVICE, AND ROBOT CONTROL PROGRAM

(71) Applicant: THE UNIVERSITY OF TOKYO, Tokyo (JP)

(72) Inventors: Masatoshi ISHIKAWA, Tokyo (JP); Taku SENOO, Tokyo (JP); Yuji YAMAKAWA, Tokyo (JP); Shouren HUANG, Tokyo (JP)

(21) Appl. No.: 17/431,485

(22) PCT Filed: Feb. 25, 2020
(86) PCT No.: PCT/JP2020/007310

§ 371 Date: Aug. 17, 2021

(30) Foreign Application Priority Data
Feb. 25, 2019 (JP) 2019-031790

(51) Int. Cl. B25J 9/16; B25J 13/08; B25J 11/00

(52) U.S. Cl. CPC B25J 9/1692; B25J 11/005; B25J 9/1633; B25J 13/08

(57) ABSTRACT

A robot system is provided, comprising: a robot including a first sensor configured to measure a displacement quantity of a coordinate position between a work point and a target point defined for each of a plurality of objects with different shapes or a physical quantity that changes due to the displacement quantity at a first operation frequency; and a control apparatus for controlling the robot, including a coarse operation management unit configured to move the target point to the vicinity of the object at a second operation frequency, a calculation control unit configured to generate a control signal to correct the displacement quantity at a third operation frequency in such a manner that the target point approaches the work point, and a correction drive unit configured to execute a correction operation to align the target point with the work point based on the control signal; wherein the second operation frequency is a frequency less than or equal to ½ of the first and third operation frequencies.

### CROSS REFERENCE TO RELATED APPLICATIONS

This application is a U.S. National Phase application under 35 U.S.C. 371 of International Application No. PCT/JP2020/007310, filed on Feb. 25, 2020, which claims priority to Japanese Patent Application No. 2019-031790, filed on Feb. 25, 2019. The entire disclosures of the above applications are expressly incorporated by reference herein.

### BACKGROUND

### Technical Field

The present invention relates to a robot for industrial, medical, domestic use or the like, especially relates to a robot system, a control apparatus of a robot, and a control program of the robot that need to work with high-accuracy.

### Related Art

The use of robots is rapidly increasing in industrial fields such as industry, commerce, and agriculture, in medical fields such as surgery, nursing, and care, and even in households such as cleaning. Among these fields, for example in production fields, objects of the robots are frequently changing in accordance with diversifying needs such as custom-made production or high-mix low-volume production. Therefore, the robots are required to respond quickly and flexibly. Further, high-accuracy work is essential to achieve high-quality.

Patent Application Publication No. 5622250 discloses an apparatus for executing high-accuracy work processing. In Patent Application Publication No. 5622250, as described in claim 1, an apparatus projects a reference pattern from a projection means onto a work to be machined, calculates a displacement data by imaging the work with the projected reference pattern, corrects a three-dimensional machining data based on the displacement data, and matches a machining origin of an industrial robot with a machining origin of the work.

Although Patent Application Publication No. 5622250 improves machining accuracy by projecting and imaging a reference pattern and correcting machining data, the following problems still exist. Every time a work to be machined is changed, a reference pattern must be created and a jig to hold the work with high positioning accuracy is required, thus the work to be machined cannot be easily changed. Moreover, since an image capturing camera is fixed at a place far from a machining origin, it is impossible to execute a highly accurate observation at the machining origin.

The present invention has been made in view of the above circumstances and provides a robot system, a robot control apparatus, and a robot control program of the robot capable of executing a high-accuracy work without preparing a jig corresponding to the objects even when the objects are in different shapes.

### SUMMARY

According to the present invention, provided is a robot system, comprising: a robot including a first sensor configured to measure a displacement quantity of a coordinate position between a work point and a target point defined for each of a plurality of objects with different shapes or a physical quantity that changes due to the displacement quantity at a first operation frequency; and a control apparatus for controlling the robot, including a coarse operation management unit configured to move the target point to the vicinity of the object at a second operation frequency, a calculation control unit configured to generate a control signal to correct the displacement quantity at a third operation frequency in such a manner that the target point approaches the work point, and a correction drive unit configured to execute a correction operation to align the target point with the work point based on the control signal; wherein the second operation frequency is a frequency less than or equal to ½ of the first and third operation frequencies.

In the robot system of the present invention, the displacement of the coordinate position between the work point and the target point, which is defined for each object, can be measured by the first sensor, and the position of the target point can be corrected via the correction drive unit. At this time, the first operation frequency, which is an operation frequency of the first sensor, and the third operation frequency of the calculation control unit are higher than twice the operation frequency of the coarse operation management unit, which enables quick positioning. In other words, even when the objects are individually different in shape, high-accuracy work can be executed smoothly without preparing a jig corresponding to the objects.

### BRIEF DESCRIPTION OF THE DRAWINGS

FIG. 1 is a functional block diagram of a robot system according to embodiments of the present invention.

FIG. 2 is a configuration diagram of an object action unit and a first sensor of a robot according to a first embodiment.

FIG. 3 is a diagram showing work position image information of the robot according to the first embodiment.

FIG. 4 is a single work control flow diagram of the robot system according to the first embodiment.

FIG. 5 is a continuous work control flow diagram of the robot system according to the first embodiment.

FIG. 6 is a configuration diagram of an object action unit and a first sensor of a robot according to a second embodiment.

FIG. 7 is a continuous work control flow diagram with online correction according to a third embodiment.

FIG. 8 is a schematic diagram of a neural network according to a fourth embodiment.

FIG. 9 is a conceptual diagram of a high-level intelligent robot system using artificial intelligence according to the fourth embodiment.

FIG. 10 is a control flow diagram for measuring high-accuracy position information before work according to a fifth embodiment.

### DETAILED DESCRIPTION

Hereinafter, embodiments of the present invention will be described with reference to the drawings. Various features described in the embodiment below can be combined with each other. In particular, the “unit” in the present invention may include, for instance, a combination of hardware resources implemented by circuits in a broad sense and information processing of software that can be concretely realized by these hardware resources. Further, although various information is executed in the present embodiment, this information can be represented by high and low signal values as a bit set of binary numbers composed of 0 or 1, and communication/calculation can be executed on a circuit in a broad sense.

Further, the circuit in a broad sense is a circuit realized by combining at least an appropriate number of a circuit, a circuitry, a processor, a memory, and the like. In other words, it is a circuit includes Application Specific Integrated Circuit (ASIC), Programmable Logic Device (e.g., Simple Programmable Logic Device (SPLD), Complex Programmable Logic Device (CPLD), and Field Programmable Gate Array (FPGA)), and the like.

### 1. Overall Configuration

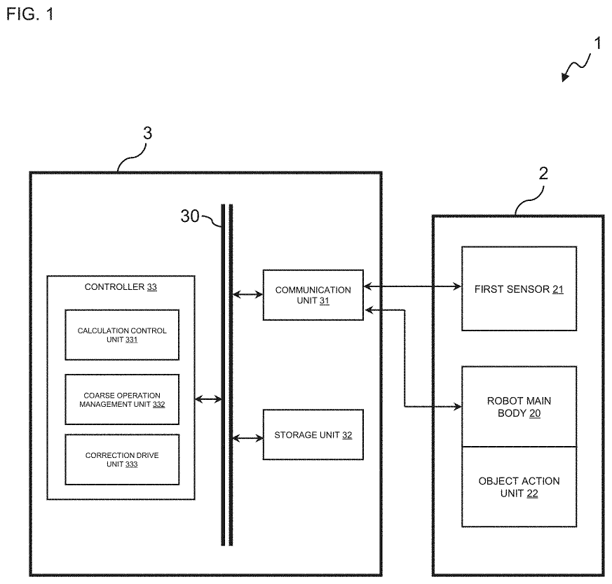

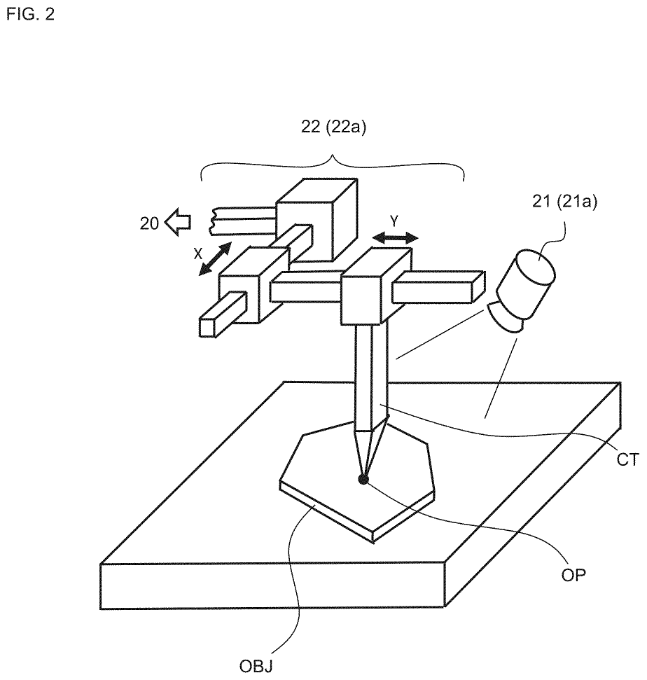

In unit 1, the overall configuration of a robot system 1 will be described with the drawings. FIG. 1 is a diagram showing a configuration outline of the robot system 1 according to the present embodiment. The robot system 1 comprises a robot 2 and a control apparatus 3 for controlling the robot 2, which are electrically connected to each other. The robot system 1 executes a predetermined work on an object OBJ (see FIG. 2), which is given for each work.

### 1.1 Robot 2

In the robot system 1 of the present embodiment, the overall form of the robot 2 is not particularly limited, but is characterized by comprising a first sensor 21 and an object action unit 22 (target point). The details of these two components will be described later. Further, other functions generally possessed by robots, such as a user interface function for specifying a work to be executed by an operator, a function for supplying the object OBJ, and a static position adjustment function, are assumed to be executed by a main body 20 in the drawings and will not be described in detail here.

The object action unit 22 is configured to displace the coordinate position and to execute a predetermined work on multiple types of objects OBJ with different individual shapes. The displacement method of the coordinate position is not limited, any method such as an axial sliding type or an articulated type can be used.

The first sensor 21 is configured to measure a distance d, which is a displacement quantity of the coordinate position between a work point OP defined for each object OBJ and the object action unit 22 (target point), or a force or a torque, which is a physical quantity that changes due to the displacement quantity of the coordinate positions. The operation frequency of the first sensor 21 is defined as a first operation frequency. The measurement method for measuring the distance d, which is the displacement quantity of the coordinate positions, the force or the torque is not limited, any method can be used such as a camera that detects at least one of visible light, infrared light, and ultraviolet light, an ultrasonic sonar, and a torque sensor. Hereinafter, for the sake of simplicity, a method for measuring the distance d, which is the displacement quantity, will be described.

FIG. 2 shows a configuration using a high-speed two-dimensional actuator 22a as the object action unit 22 and a monocular high frame rate camera 21a as the first sensor 21. The main body 20 is not shown. The high-speed two-dimensional actuator 22a is configured to move on the horizontal plane in each of x-axis and y-axis, and a cutting tool CT is arranged on a tip of the high-speed two-dimensional actuator 22a as an example. In FIG. 2, although the cutting tool CT is arranged for cutting a working content of the robot system, it can be replaced with a coating tool, a laser injection unit, or the like as appropriate according to the work content of the robot system.

The high frame rate camera 21a, which is the first sensor 21 in FIG. 2, is capable of acquiring information within a specific visual field as an image signal. Here, the camera is arranged to capture the cutting tool CT and the work point OP on the object OBJ within the visual field. For high-speed and high-accuracy positioning, a frame rate (first operation frequency) of 100 fps or higher is preferable, and 500 fps or higher is even more preferable. Specifically, for example, 100, 120, 140, 160, 180, 200, 220, 240, 260, 280, 300, 320, 340, 360, 380, 400, 420, 440, 460, 480, 500, 520, 540, 560, 580, 600, 620, 640, 660, 680, 700, 720, 740, 760, 780, 800, 820, 840, 860, 880, 900, 920, 940, 960, 980, 1000, 1020, 1040, 1060, 1080, 1100, 1120, 1140, 1160, 1180, 1200, 1220, 1240, 1260, 1280, 1300, 1320, 1340, 1360, 1380, 1400, 1420, 1440, 1460, 1480, 1500, 1520, 1540, 1560, 1580, 1600, 1620, 1640, 1660, 1680, 1700, 1720, 1740, 1760, 1780, 1800, 1820, 1840, 1860, 1880, 1900, 1920, 1940, 1960, 1980, 2000, and may be in the range between any two of the numerical values illustrated above.

Although the high frame rate camera 21a can be fixed in a position to overlook the entire object OBJ, the high frame rate camera 21a can always follow the work point OP to acquire magnified image information with high-accuracy by mechanically interlocking with the object action unit 22. In this case, it is preferable that a second sensor (unshown) is separately arranged for the coarse operation management unit 33, which will be described later, and both the object action unit 22 and the high frame rate camera 21a move to the vicinity of the object OBJ based on a measurement result of the second sensor. In particular, it should be noted that the high frame rate camera 21a measures the displacement quantity as two-dimensional coordinate information, and the correction drive unit 33 described later executes a two-dimensional correction operation.

### 1.2 Control Apparatus 3

As shown in FIG. 1, the control apparatus 3 comprises a communication unit 31, a storage unit 32, and a controller 33, and these components are electrically connected via a communication bus 30 inside the control apparatus 3. Hereinafter, each component will be described in detail.

### <Communication Unit 31>

The communication unit 31 exchanges information with the robot 2. Although wired communication means such as USB, IEEE1394, Thunderbolt, and wired LAN network communication are preferable, wireless LAN network communication, mobile communication such as 5G/LTE/3G, Bluetooth (registered trademark) communication or the like may be included as necessary. The communication means illustrated above are only examples, and a dedicated communication standard may be adopted as well. In other words, it is more preferable to carry out as a set of a plurality of the aforementioned communication means.

In FIG. 1, although the communication unit 31 is connected to the first sensor 21 and the main body 20 in the robot 2 separately, the physical connections may be collected one and may be configured to be logically distributed in the robot 2.

### <Storage Unit 32>

The storage unit 32 is a volatile or non-volatile storage media that stores various information. For example, the storage unit 32 can be implemented as a storage device such as a solid state drive (SSD) or as a memory such as a random access memory (RAM) that stores temporarily necessary information (arguments, arrays, etc.) regarding program operation, and any combination thereof.

In particular, the storage unit 32 stores various parameters regarding different work types and work contents, information regarding shapes and materials of different objects OBJ, and past work position information during continuous work.

The storage unit 32 stores various programs or the like regarding the control apparatus 3 that are executed by the controller 33. Specifically, for example, the storage unit 32 stores a program that executes coarse operation management of the object action unit 22 defined for each object OBJ, calculates the displacement of the coordinate position between the work point OP defined for each object OBJ and the object action unit 22 based on the information input from the first sensor 21, and calculates and instructs a correction operation to the object action unit 22 to make the object action unit 22 approach the work point OP.

### <Controller 33>

The controller 33 processes and controls overall operations regarding the control apparatus 3. The controller 33 is, for example, an unshown central processing unit (CPU). The controller 33 realizes various functions related to the control apparatus 3 by reading out a predetermined program stored in the storage unit 32. Specifically, the controller 33 realize functions of calculating the coordinate position displacement information between the work point OP defined for each object OBJ and the current object action unit 22 based on the information given in advance for each object OBJ and the information from the first sensor 21 and other sensors, managing the coarse operation of the object action unit 22 and the first sensor 21, and executing correction operation of the object action unit 22 with high-accuracy.

In other words, information processing by software (stored in the storage unit 32) can be specifically realized by hardware (controller 33) to be executed as a calculation control unit 331, a coarse operation management unit 332, and a correction drive unit 333. Although the controller 33 is indicated as a single one in FIG. 1, it is not limited to this, and may be implemented to have a plurality of controllers 33 for each function, or any combination thereof. Hereinafter, the calculation control unit 331, the coarse operation management unit 332, and the correction drive unit 333 will be described in detail.

### [Calculation Control Unit 331]

The calculation control unit 331 is one in which information processing by software (stored in the storage unit 32) is specifically realized by hardware (controller 33). The calculation control unit 331 executes operations to identify spatial coordinates of the work point OP and the object action unit 22 based on the information acquired from the first sensor 21 via the communication unit 31 and the parameters given in advance for each object OBJ. At this time, the frequency of the calculation is the first operation frequency, which is the operation frequency of the first sensor 21. For example, in the case of the configuration shown in FIG. 2, the parameters include the shape or length of the cutting tool CT, the thickness of the object OBJ, or the brightness threshold for image recognition of the mark preliminarily attached to the work point OP, or the like. A control signal to correct the position is generated based on the acquired displacement information between the spatial coordinates of the work point OP and the object action unit 22. The control signal is utilized by the correction drive unit 333 alone or by both the coarse operation management unit 332 and the correction drive unit 333 as described below.

The calculation frequency to generate the control signal is defined as a third operation frequency. Although there is no problem even if the third operation frequency is the same as the first operation frequency, there is no need to be the same. By having the first and third operation frequencies at high frequencies, the robot system 1 as a whole can execute high-speed work.

Further, when a second sensor exists, the calculation control unit 331 executes a calculation to identify the spatial coordinates of the work point OP and the object action unit 22 based on the information obtained from the second sensor via the communication unit 31 and the parameters given in advance for each object OBJ. The spatial coordinates calculated based on the information from the second sensor are not necessarily more accurate than the spatial coordinates calculated from the first sensor 21, and the update frequency (operation frequency) is also not as high as the first operation frequency, which is the operation frequency of the first sensor. The spatial coordinate position information calculated from the second sensor is utilized by the coarse operation management unit 332.

### [Coarse Operation Management Unit 332]

The coarse operation management unit 332 is one in which information processing by software (stored in the storage unit 32) is specifically realized by hardware (controller 33). The coarse operation management unit 332 manages a coarse operation of the object action unit 22 alone or coarse operations of both the object action unit 22 and the first sensor 21. Here, the coarse operation means that the object action unit 22 alone or both the object action unit 22 and the first sensor 21 are brought close to the work point OP defined for each object OBJ. The vicinity of the work point may be as follows: when utilizing the information defined in the software stored in the storage unit 32, when utilizing the spatial coordinate position information calculated by the calculation control unit 331 based on the information from the first sensor 21, or when utilizing the spatial coordinate position information calculated by the calculation control unit 331 based on the information from the second sensor. Further, any combination thereof may be utilized.

The operation frequency at which the coarse operation management unit 332 adjusts the position of the object action unit 22 is defined as a second operation frequency. In the present invention, the second operation frequency is ½ or less than the first operation frequency, which is the operation frequency of the first sensor, and the third operation frequency, which is the operation frequency of the calculation control unit 331 described below. By setting the operation of the coarse operation management unit 332 to a low frequency in this way, the main body 20 can be utilized for coarse operation even when the main body 20 is relatively large and react slowly. Note that when using the spatial coordinate position information updated by the first operation frequency calculated from the first sensor 21, the update frequency of the information is reduced to about the second operation frequency by thinning out the information on the time axis or averaging a plurality of information or the like.

### [Correction Drive Unit 333]

The correction drive unit 333 is one in which information processing by software (stored in the storage unit 32) is specifically realized by hardware (controller 33). Based on the position correction signal provided by the calculation control unit 331, the correction drive unit 333 executes position correction with respect to the object action unit 22 to align the action point of the object action unit 22 with the action point defined for each object OBJ. In this case, highly accurate coordinate position alignment within a range of spatial resolution of the first sensor 21 and the object action unit 22 becomes possible.

### 2. Control Method of Robot 2

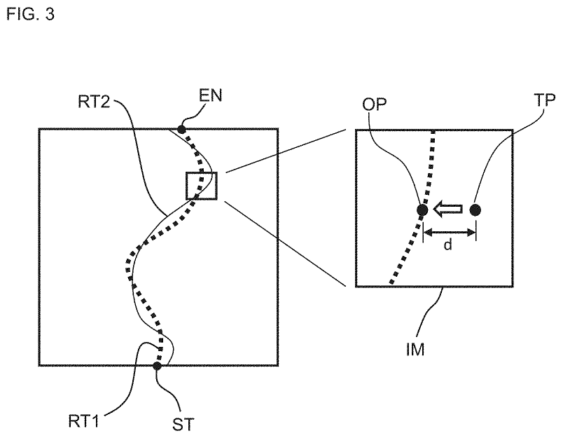

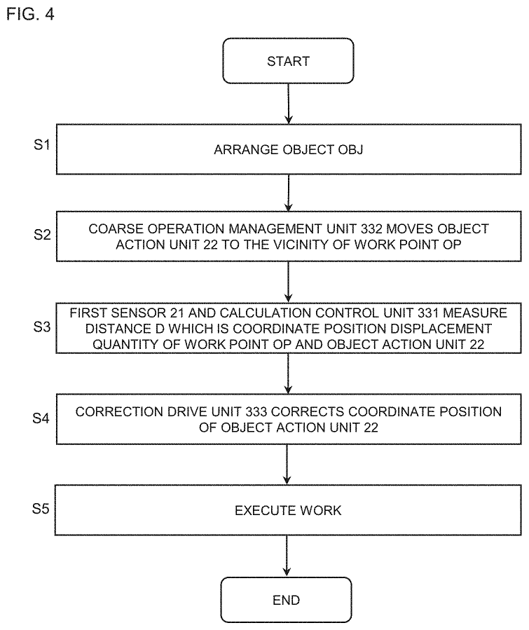

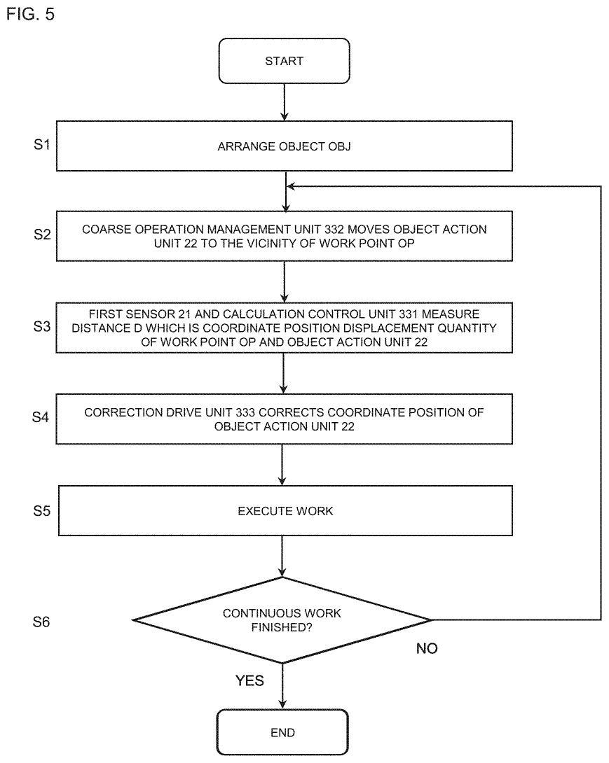

In section 2, a control method of the robot 2 in the robot system 1 for the robot to perform highly accurate work on each object OBJ will be described. As a specific example, FIG. 3 shows image information obtained by capturing a part of the object OBJ with the high frame rate camera 21a in the configuration illustrated in FIG. 2. Further, FIG. 4 shows a control flow during single work, and FIG. 5 shows a control flow during continuous work. Hereinafter, a description will be made with reference to the drawings.

### 2.1 Single Work Control Flow

The single work control flow is a control flow when the robot system 1 executes single work on the object OBJ. See FIG. 4 for the control flow diagram.

### [Single Work Started]

### (Step S1)

The object OBJ is arranged in a robot workable area. It is sufficient that the positioning accuracy at this time is determined by the subsequent processing, the work point OP (designated point for work) on the object OBJ and the action point TP (target point) of the object action unit 22 (tip of the cutting tool CT) exist in a visual field of the first sensor 21 (high frame rate camera 21a) and the object action unit 22 (high-speed two-dimensional actuator 22a), and enter a correction operation allowable range of the object action unit 22 (high-speed two-dimensional actuator 22a). It is not necessary to prepare a jig for holding the object OBJ manufactured with high-accuracy only for positioning.

### (Step S2)

The coarse operation management unit 332 moves the object action unit 22 to the vicinity of the work point OP on the object OBJ. At this time, the work point OP may be used by inputting the coordinate position information of the work point OP for each object OBJ, which has been stored in the storage unit 32 in advance, to the coarse operation management unit 332. Alternatively, as the second sensor, a method may be utilized in which the coarse operation management unit 332 uses the coordinate information obtained as a calculation result of inputting the image information acquired from a general camera into the calculation control unit 331.

### (Step S3)

FIG. 3 shows a time point when the coarse operation management in step S2 is ended. The left side of FIG. 3 is an overall view of the object OBJ, and the right side of FIG. 3 is an image data IM taken by the high frame rate camera 21a. There is a position displacement of a distance d occurs between the work point OP and the tip position TP of the cutting tool CT. The image information captured by the high frame rate camera 21a (first sensor 21) is input to the calculation control unit 331 via the communication unit 31, and the calculation control unit 331 calculates the coordinate position displacement quantity information.

### (Step S4)

The coordinate position displacement information obtained in step S3 is transmitted to the correction drive unit 333. The correction drive unit 333 executes coordinate position correction movement control for the high-speed two-dimensional actuator 22a (object action unit 22) in such a manner that the tip position TP of the cutting tool CT approaches the work point OP. As a result, the work point OP and the tip position TP of the cutting tool CT can be brought close to each other with high-accuracy within the range of spatial resolution of the high frame rate camera 21a (first sensor 21) and the high-speed two-dimensional actuator 22a (object action unit 22).

### (Step S5)

Robot 2 executes a work on the object OBJ.

### [Single Work Ended]

### 2.2 Continuous Work Control Flow

The continuous work control flow is a control flow when the robot system 1 executes continuous work on the object OBJ. See FIG. 5 for the control flow diagram.

### [Continuous Work Started]

### (Step 1)

The object OBJ is arranged in a workable area of the robot 2. The explanation will be given with FIG. 3. The left side of FIG. 3 shows an example of image information during continuous supplementary operation. The dotted line on the left side of FIG. 3 is a linear continuous work designated position RT1. First, the work start position on the continuous work designated position RT1 is set as the continuous work start point ST, and the object OBJ is arranged in the workable area of the robot with respect to the continuous work start point ST. It is sufficient that the position accuracy at this time is determined by the subsequent processing, the continuous work start point ST on the object OBJ and the action point (tip of the cutting tool CT) TP (target point) of the object action unit 22 (high-speed two-dimensional actuator 22a) exist in the visual field of the first sensor 21 (high frame rate camera 21a), and enter a correction operation allowable range of the object action unit 22 (high-speed two-dimensional actuator 22a), which is the same as for the single work. It is not necessary to prepare a jig for holding the object OBJ manufactured with high-accuracy only for positioning, which is also the same as for the single work.

### (Step S2)

The coarse operation management unit 332 moves the object action unit 22 to the vicinity of the work point OP updated for each work, starting from the continuous work start point ST on the continuous work designated position RT1 on the object OBJ and moving in the direction of the continuous work end point EN for each work. In this case, the work point OP may be used by inputting the coordinate position information of the work point OP to the coarse operation management unit 332, wherein the coordinate position information of the work point OP is stored in the storage unit 32 in advance and is updated for each work on the continuous work designated position RT1 for each object OBJ. Alternatively, as the second sensor, a method may be utilized in which the coarse operation management unit 332 uses the coordinate information obtained as a calculation result of inputting the image information acquired from a general camera into the calculation control unit 331, which is the same as for the single work. The continuous work designated position RT1 can be explicitly indicated by the operator such as applying a mark, or can be utilized by image-recognizing a boundary line if the boundary line can be defined as the continuous work designated position RT1 in the case where there are multiple objects in the object OBJ or the like. A control trajectory RT2 on the left side of FIG. 3 indicates a trajectory where the coarse operation management unit 332 has executed a control. It is important that the distance of the control trajectory RT2 of the coarse operation management unit 332 with respect to the continuous work designated position RT1 is within the visual field of the first sensor 21 (high frame rate camera 21a) and within a correction operation range of the object action unit 22.

### (Step S3)

The coordinate position displacement measurement and the correction work for each work within the continuous operation are the same as for the single work. FIG. 3 shows a time point when the coarse operation management in step S2 is ended. The right side of FIG. 3 shows the image data IM captured by the high frame rate camera 21a. There is a position displacement (distance d) occurs between the work point OP and the tip position TP of the cutting tool CT. The image information captured by the high frame rate camera 21a (first sensor 21) is input to the calculation control unit 331 via the communication unit 31, and the calculation control unit 331 calculates the coordinate position displacement quantity information.

### (Step S4)

The coordinate position displacement information obtained in step S3 is transmitted to the correction drive unit 333. The correction drive unit 333 executes coordinate position correction movement control for the high-speed two-dimensional actuator 22a (object action unit 22) in such a manner that the tip position TP of the cutting tool CT approaches the work point OP. As a result, the work point OP and the tip position TP of the cutting tool CT can be brought close to each other with high-accuracy within the range of spatial resolution of the high frame rate camera 21a (first sensor 21) and the high-speed two-dimensional actuator 22a (object action unit 22), which is the same as for the single work.

### (Step S5)

Robot 2 executes a work on the object OBJ, which is the same as for the single work.

### (Step S6)

This step determines whether the continuous work has been finished, which can be determined by checking whether all the work at the continuous work designated position RT1 for each object OBJ stored in the storage unit 32 in advance is finished. Alternatively, if a general camera is used as the second sensor, the stage of the continuous work may be determined, for example, that the end point of the marked work instruction line has been reached or the like. If the continuous work is not finished, the process returns to step S2 to continue the work.

### [Continuous Work Ended]

### 2.3 Result

By implementing the various control methods as described above, the robot 2 can be controlled with high-accuracy without preparing a jig for holding the object OBJ even if the shape of each object OBJ is different. The loop is broken out when a series of continuous work is finished.

### 3. Modifications

In section 3, modifications according to the present embodiment will be described. In other words, the robot system 1 according to the present embodiment may be implemented in the following manners.

### [Three-Dimensional Coordinate Displacement Correction Operation]

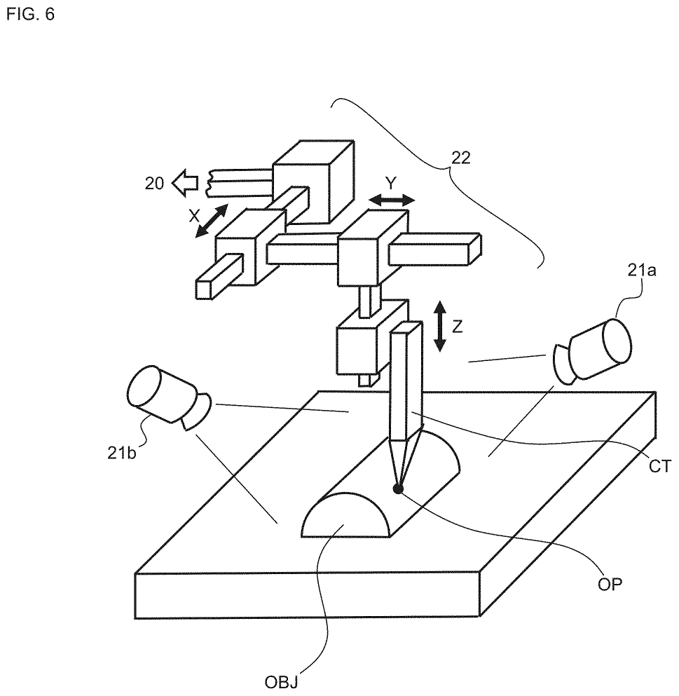

FIG. 6 shows a configuration diagram of an embodiment of a three-dimensional position displacement correction operation. The main body 20 is not shown in FIG. 6. A high-speed three-dimensional actuator 22b is configured to move on a three-dimensional coordinate in each of x-axis, y-axis, and z-axis, and a cutting tool CT is arranged on a tip of the high-speed three-dimensional actuator 22b as an example. In FIG. 6, although the cutting tool CT is arranged for cutting a work content of the robot system, it can be replaced with a coating tool, a laser injection unit or the like as appropriate according to the work content of the robot system 1.

As an example of the first sensor 21, two high frame rate cameras 21a and 21b are arranged. If image information of the object OBJ is acquired from different angles by using two or more optical cameras, the three-dimensional coordinate of the work point OP on the object OBJ can be clarified by calculation in the calculation control unit 331. Even in three-dimensional measurement, the requirements for each of the high frame rate cameras 21a and 21b are the same as for the two-dimensional high frame rate camera 21a described in sections 1 and 2, and for the purpose of high-speed and high-accuracy positioning, a high frame rate (imaging rate) of 100 fps or higher is preferable, and 500 fps or higher is even more preferable. Specific examples are omitted. Although the high frame rate cameras 21a and 21b can be fixed in a position to overlook the entire object OBJ, the high frame rate cameras 21a and 21b can always follow the work point OP to acquire magnified image information with high-accuracy by mechanically interlocking with the object action unit 22 (target point), which is the same as in the case of a two-dimensional correction. It should be noted that the high frame rate cameras 21a and 21b measure the displacement quantity as three-dimensional coordinate information, and the correction drive unit 333 executes a three-dimensional correction operation.

As shown in FIG. 6, the robot system 1 with three-dimensional coordinate position displacement correction can be realized by preparing a first sensor 21 capable of executing spatial three-dimensional coordinate measurement and an object action unit 22 capable of executing three-dimensional correction movement. In this case, the control flow described in section 2 can be applied accordingly as it is.

[Continuous Work with Online Correction]

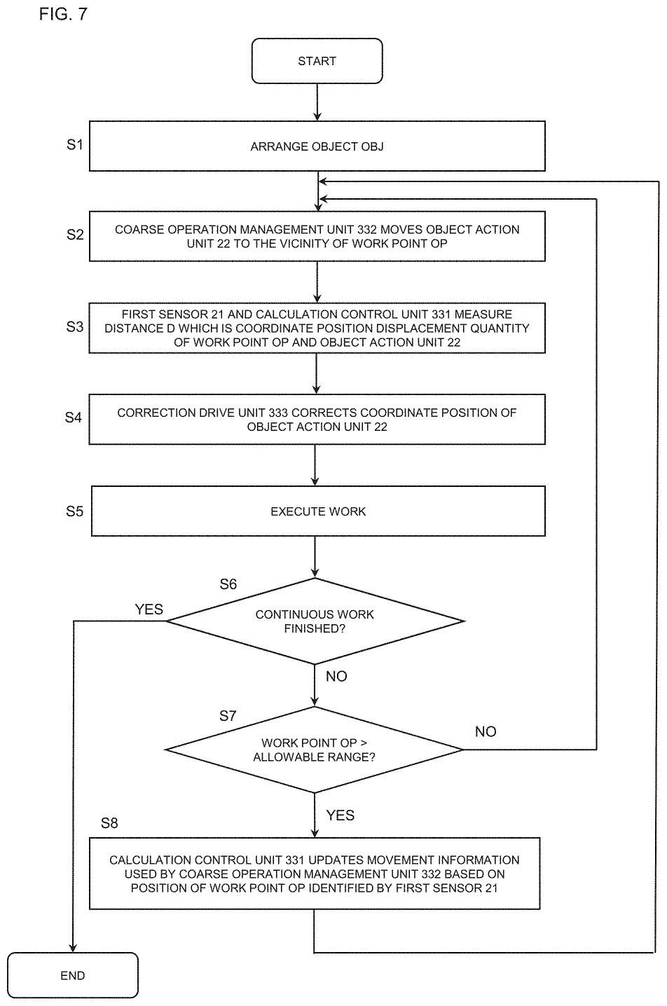

In the continuous work control flow described in section 2.2, the continuous work designated position RT1 used by the coarse operation management unit 332 is stored in the storage unit 32 in advance, or the method that uses information from the second sensor (such as a general camera) is adopted. Here, a control flow of an embodiment in which the movement information used by the coarse operation management unit 332 is updated based on the work point coordinate position identified by the first sensor 21 will be described. A configuration diagram of the object action unit 22 (target point) and the first sensor 21 can be referred to FIG. 2, image information can be referred to FIG. 3, and a control flow diagram can be referred to FIG. 7.

### [Continuous Work Started]

### (Step S1)

The object OBJ is placed in the workable area of the robot 2. The description thereof is omitted since this step is the same as for the continuous work in section 2.2.

### (Step S2)

The coarse operation management unit 332 moves the object action unit 22 to the vicinity of the work point OP updated for each work, starting from the continuous work start point ST on the continuous work designated position RT1 on the object OBJ and moving in the direction of the continuous work end point EN for each work. The movement information at this time may be updated using the work point OP information identified by the first sensor 21, as described later in step S8. The continuous work designated position RT1 can be explicitly indicated by the operator such as applying a mark, or can be utilized by image-recognizing a boundary line if the boundary line can be defined as the continuous work designated position RT1 in the case where there are multiple objects in the object OBJ or the like, which is the same as in section 2.2.

### (Step S3)

The coordinate position displacement measurement and the correction work for each work within the continuous operation is the same as for the single work in section 2.1 and for the continuous work in section 2.2, thus the description thereof is omitted. Information on where the work point OP identified by the high frame rate camera 21a (first sensor 21) exists in the image data IM in FIG. 3 is used in steps S7 and S8 described later.

### (Step S4)

The coordinate position displacement information obtained in step S3 is transmitted to the correction drive unit 333, and the coordinate position correction movement control implemented with respect to the object action unit 22 is the same as for the single work in section 2.1 and for the continuous work in section 2.2, thus the description thereof is omitted.

### (Step S5)

Robot 2 executes a work on the object OBJ, which is the same as for the single work in section 2.1 and for the continuous work in section 2.2.

### (Step S6)

This step determines whether all the steps of the continuous work stored in the storage unit 32 in advance have been finished. If the continuous work is not finished, the process returns to step S7 to continue the work.

### (Step S7)

This step determines whether to update the movement information used by the coarse operation management unit 332, by checking whether the work point OP identified by the high frame rate camera 21a (first sensor 21) in step S3 is located within the allowable range of the image data IM. Specifically, for instance, if it can be estimated that the current work point OP is located near the center of the image data IM, and the position displacement of the distance d between the next work point and the tip position TP of the cutting tool CT (object action unit 22) is small enough in a range for the correction drive unit to execute processing, then the process returns to step S2 to continue the work at the current position under the allowable range. If it is determined that the allowable range is exceeded, then the process proceeds to step S8. It is also possible to set the allowable range, which is a threshold value, to 0 and always proceed to step S8.

### (Step S8)

The movement information used in the coarse operation management unit 332 is updated based on the work point OP information identified by the high frame rate camera 21a (first sensor 21). Specifically, for instance, if the work point OP displaces upward from the center in the image data IM, the work point OP can be brought closer to the center direction by moving the robot 2 upward. The calculation control unit 331 executes such calculation, updates the movement information used by the coarse operation management unit 332, and returns to step S2 to continue the continuous work.

In this case, if there is a means to measure the actual movement distance such as an encoder in the high-speed two-dimensional actuator 22a (object action unit 22), the calculation can also be executed taking into account the actual movement distance information measured in the object action unit 22.

### [Continuous Work Ended]

### [Accurate and Efficient Product Processing Using Artificial Intelligence]

By adding machine learning, which is being actively researched in the field of artificial intelligence (AI), to the robot system 1 according to the present embodiment, accurate and efficient product processing can be expected. As described in [Means for Solving Problem], the robot system 1 is particularly suitable when the object OBJ is custom-made production or high-mix low-volume production. Although the custom-made production or the high-mix low-volume production may naturally have various specific shapes or dimensions, in terms of the attributes of the objects, many parts are common to conventional goods such as applications, materials, shapes, and dimensions. Therefore, the attributes of the objects to be machined can be machine learned by the robot system 1 in such a manner that the objects can be machined more accurately and efficiently during current machining or in future machining.

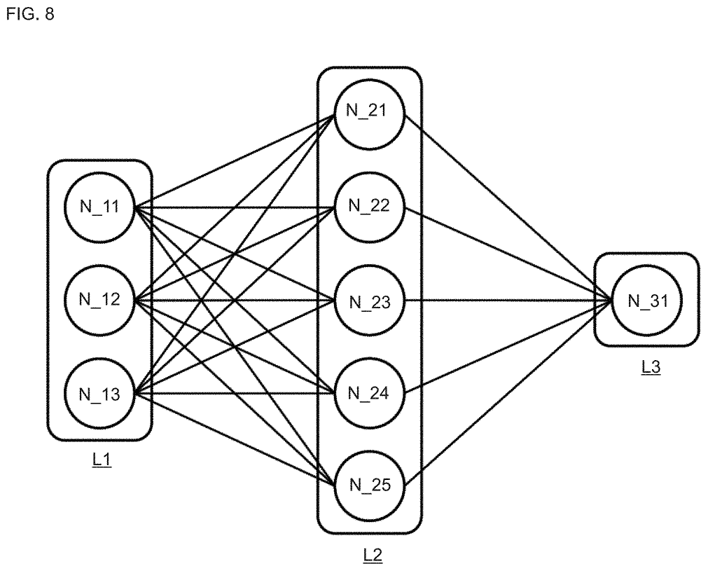

For instance, as an example of machine learning, a neural network can be adopted. FIG. 8 shows a schematic diagram of a neural network. An input signal defined by various parameters is input to a first layer L1. The input signal here is an attribute of the object to be machined (for example, information including use, material, shape, dimension, process of machining, or the like). Further, past machining data in which these attributes are known is accumulated as prior learning data. It is especially preferable to upload the data to a cloud server to share the learning data. The input signals are output from computation nodes N_11 to N_13 of the first layer L1 to computation nodes N_21 to N_25 of a second layer L2, respectively. At this time, with respect to the values output from the calculation nodes N_11 to N_13, the values obtained by multiplying a weight w set between the calculation nodes N are input to the calculation nodes N_21 to N_25.

Computation nodes N_21 to N_25 add up the input values from the computation nodes N_11 to N_13 and input these values (or values obtained by adding a predetermined bias value to the values) to a predetermined activation function. Then, the output value of the activation function is transmitted to the computation node N_31, which is the next node. At this time, the value obtained by multiplying the weight w set between the calculation nodes N_21 to N_25 and the calculation node N_31 by the output values is input to the calculation node N_31. The calculation node N_31 adds up the input values and outputs the total value as an output signal. At this time, the calculation node N_31 may add the input values together, input the total value plus the bias value to the activation function, and output the output value as an output signal. In this way, a machining plan data of the object OBJ to be machined is optimized and output. Such machining plan data is utilized, for example, for a determination of the coarse operation by the coarse operation management unit 332.

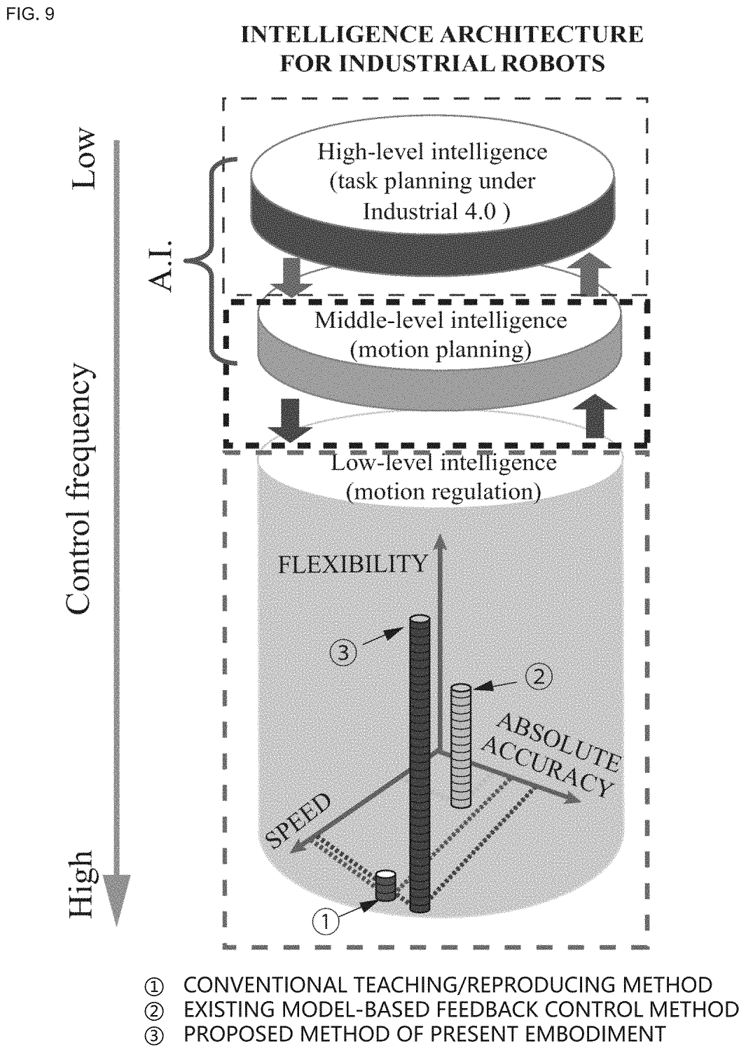

FIG. 9 shows a conceptual diagram of a high-level intelligent robot system utilizing artificial intelligence (AI). In the lower part of FIG. 9, even with low-level intelligence, the proposed method of the present embodiment can achieve high-speed (SPEED), high absolute accuracy (ABSOLUTE ACCURACY), and high-flexibility (adaptability) (FLEXIBILITY) compared to conventional teaching or reproducing methods and existing model-based feedback control methods.

In addition, by utilizing artificial intelligence (AI), the robot system 1 can evolve into middle-level intelligence or high-level intelligence and can be used for task management in Industrial 4.0.

### [Control Method to Pre-Trace Work Position]

In section 2, the case in which the robot 2 executes a predetermined work while correcting the position of the object action unit 22 with having the object action unit 22 is described. On the other hand, in cases such as when the weight of the object action unit 22 is heavy, there are some demands that the position information of the target point be executed before the actual work of the robot system 1 is grasped with high-accuracy, and the actual work of the robot system 1 should be executed in a shorter time.

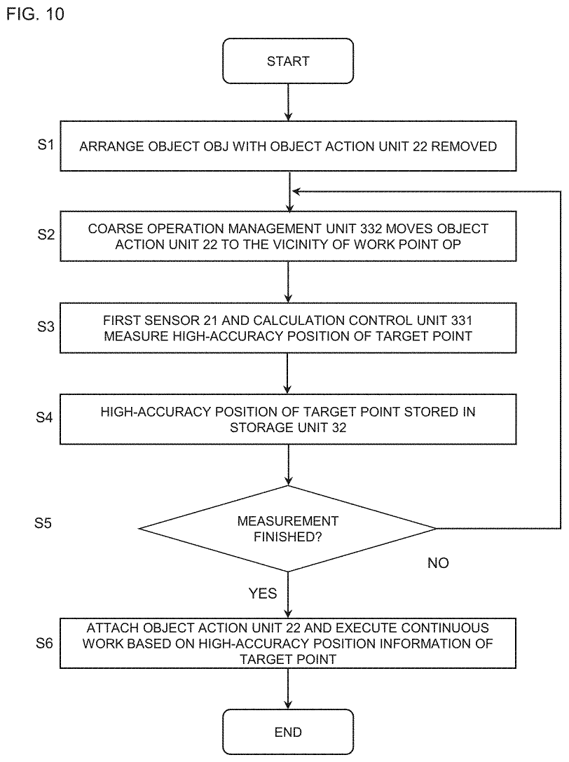

Even in this case, the object action unit 22 can be removed from the robot 2 in FIG. 1 and the first sensor 21 can be used to identify a high-accuracy position information of the target point. The control flow in the case where the actual work is continuous is shown in FIG. 10. A configuration diagram of the object action unit 22 and the first sensor 21 can be referred to FIG. 2, and image information can be referred to FIG. 3.

### [Work Started]

### (Step S1)

The object OBJ is arranged in the robot workable area with the object action unit 22 removed from the robot 2. The continuous work start point ST on the continuous work designated position RT1 on the left side of FIG. 3 at this time is set to be within the visual field of the first sensor 21 (high frame rate camera 21a). At this time, since the object action unit 22 is removed and the action point (tip of the cutting tool CT) TP of the object action unit 22 does not exist, there is no need to pay attention thereto.

### (Step S2)

Here, RT1 in FIG. 3 is used as the target point for the actual work. The coarse operation management unit 332 moves the first sensor 21 from the vicinity of the continuous work start point ST on the continuous work designated position RT1 on the object OBJ to the direction of the vicinity of the continuous work end point EN. Here, the continuous work designated position RT1 may utilize the information stored in the storage unit 32 in advance. Alternatively, as the second sensor, a method may be utilized in which the coarse operation management unit 332 uses the coordinate information obtained as a calculation result of inputting the image information acquired from a general camera into the calculation control unit 331. The continuous work designated position RT1 can be explicitly indicated by the operator such as applying a mark, or can be utilized by image-recognizing a boundary line if the boundary line can be defined as the continuous work designated position RT1 in the case where there are multiple objects in the object OBJ or the like, which is the same as for the continuous work control flow described in section 2.

### (Step S3)

High-accuracy position information of the target point is obtained from the image data IM captured by the high frame rate camera 21a (first sensor 21). The high-accuracy position information of the target point is obtained by inputting the image data IM to the calculation control unit 331 via the communication unit 31, calculating the information of the coordinate position displacement quantity from the center of the image data with the calculation control unit 331, and combining with the movement quantity by the coarse operation management unit 332.

### (Step S4)

The high-accuracy position information calculated in step S3 is stored in the storage unit 32.

### (Step S5)

This step determines whether the measurement of the entire continuous work designated positions have been finished. If the measurement is finished, the process proceeds to step S6. If not, the process returns to step S2 to continue the measurement.

### (Step S6)

The cutting tool CT (object action unit 22) is attached to the robot 2 to execute the work. At this time, the continuous work is executed while moving the tip position TP of the cutting tool CT based on the high-accuracy position information stored in the storage unit 32. Since the high-accuracy position information is stored, there is no need to execute feedback control during the work.

### [Work Ended]

### 4. Conclusion

As described above, according to the present embodiment, in the robot system 1, even if the objects OBJ have different shapes, the robot system 1 is capable of executing high-accuracy work without preparing a jig corresponding to the object OBJ can be implemented.

The robot system 1 comprising: a robot 2 including a first sensor 21 configured to measure a distance d, which is a displacement quantity of a coordinate position between a work point OP and a target point defined for each object OBJ, or a physical quantity that changes due to the displacement quantity at a first operation frequency; and a control apparatus 3 for controlling the robot 2, including a coarse operation management unit 332 configured to move the object action unit 22 to the vicinity of the object OBJ at a second operation frequency, a calculation control unit 331 configured to generate a control signal to correct the displacement quantity at a third operation frequency in such a manner that the object action unit 22 approaches the work point OP, and a correction drive unit 333 configured to execute a correction operation to align the object action unit 22 with the work point OP based on the control signal; wherein the second operation frequency is a frequency less than or equal to ½ of the first and third operation frequencies.

Further, in the robot system 1, even if the objects OBJ have different shapes, the control apparatus 3 of the robot 2 capable of executing high-accuracy work without preparing a jig corresponding to the object OBJ can be implemented.

The control apparatus 3 of the robot 2 including a first sensor 21 configured to measure a distance d, which is a displacement quantity of a coordinate position between a work point OP and a target point defined for each object OBJ, or a physical quantity that changes due to the displacement quantity at a first operation frequency, comprising: a coarse operation management unit 332 configured to move the target point (the object action unit 22) to the vicinity of the object OBJ at a second operation frequency, a calculation control unit 331 configured to generate a control signal to correct the displacement quantity at a third operation frequency in such a manner that the object action unit 22 approaches the work point OP, and a correction drive unit 333 configured to execute a correction operation to align the target point (the object action unit 22) with the work point OP based on the control signal; wherein the second operation frequency is a frequency less than or equal to ½ of the first and third operation frequencies.

In the robot system 1, even if the objects OBJ have different shapes, the software for implementing the control apparatus 3 of the robot 2 or the robot system 1 as hardware, which can execute high-accuracy work without preparing a jig corresponding to the object OBJ, can be implemented as a program. Such a program may be provided as a non-transitory computer readable media, a downloadable program from an external server, or a so-called “cloud computing” that enables an external computer to run the program and execute each function on a client terminal.

The control program of the robot 2 including a first sensor 21 configured to measure a distance d, which is a displacement quantity of a coordinate position between a work point OP and a target point defined for each object OBJ, or a physical quantity that changes due to the displacement quantity at a first operation frequency, configured to allow a computer to execute: a coarse operation management function that moves the target point (the object action unit 22) to the vicinity of the object OBJ at a second operation frequency, a calculation control function that generates a control signal to correct the displacement quantity at a third operation frequency in such a manner that the target point (the object action unit 22) approaches the work point OP, and a correction drive function that executes a correction operation to align the target point (the object action unit 22) with the work point OP based on the control signal; wherein the second operation frequency is a frequency less than or equal to ½ of the first and third operation frequencies.

Finally, various embodiments of the present invention have been described, but these are presented as examples and are not intended to limit the scope of the invention. The novel embodiment can be implemented in various other forms, and various omissions, replacements, and changes can be made without departing from the abstract of the invention. The embodiment and its modifications are included in the scope and abstract of the invention and are included in the scope of the invention described in the claims and the equivalent scope thereof.

1. A robot system, comprising:
a robot including a first sensor configured to measure a displacement quantity of a coordinate position between a work point and a target point defined for each of a plurality of objects with different shapes or a physical quantity that changes due to the displacement quantity at a first operation frequency; and
a control apparatus for controlling the robot, including
a coarse operation management unit configured to move the target point to the vicinity of the object at a second operation frequency,
a calculation control unit configured to generate a control signal to correct the displacement quantity at a third operation frequency in such a manner that the target point approaches the work point, and
a correction drive unit configured to execute a correction operation to align the target point with the work point based on the control signal; wherein
the second operation frequency is a frequency less than or equal to ½ of the first and third operation frequencies.

2. The robot system according to claim 1, wherein:
the physical quantity that changes due to the displacement quantity is
a force or a torque.

3. The robot system according to claim 1, wherein:
the target point is an object action unit,
the object action unit is
configured to displace the coordinate position, and
configured to execute a predetermined work on the object.

4. The robot system according to claim 3, wherein:
the object action unit includes a cutting tool, a coating tool, or a laser provision unit.

5. The robot system according to claim 3, further comprising:
a second sensor different from the first sensor, wherein
the first sensor is configured to operate in conjunction with the object action unit,
the second sensor is configured to measure the work point, and
the coarse operation management unit is configured to move the object action unit to the vicinity of the object based on a measurement result of the second sensor.

6. The robot system according to claim 1, wherein:
the first sensor is a monocular camera configured to measure the displacement quantity as two-dimensional coordinate information, and
the correction drive unit is configured to execute the correction operation of two dimensions.

7. The robot system according to claim 1, wherein:
the first sensor is a plurality of cameras configured to measure the displacement quantity as three-dimensional coordinate information, and
the correction drive unit is configured to execute the correction operation of three dimensions.

8. The robot system according to claim 1, wherein:
the first and third operation frequencies are 100 Hz or higher.

9. The robot system according to claim 1, wherein:
the robot system is configured to update a movement information used by the coarse operation management unit based on the work point coordinate position identified by the first sensor.

10. A control apparatus of a robot including a first sensor configured to measure a displacement quantity of a coordinate position between a work point and a target point defined for each of a plurality of objects with different shapes or a physical quantity that changes due to the displacement quantity at a first operation frequency, comprising:
a coarse operation management unit configured to move the target point to the vicinity of the object at a second operation frequency,
a calculation control unit configured to generate a control signal to correct the displacement quantity at a third operation frequency in such a manner that the target point approaches the work point, and
a correction drive unit configured to execute a correction operation to align the target point with the work point based on the control signal; wherein
the second operation frequency is a frequency less than or equal to ½ of the first and third operation frequencies.

11. A non-transitory computer readable media storing a control program of a robot including a first sensor configured to measure a displacement quantity of a coordinate position between a work point and a target point defined for each of a plurality of objects with different shapes or a physical quantity that changes due to the displacement quantity at a first operation frequency,
configured to allow a computer to execute:
a coarse operation management function that moves the target point to the vicinity of the object at a second operation frequency,
a calculation control function that generates a control signal to correct the displacement quantity at a third operation frequency in such a manner that the target point approaches the work point, and
a correction drive function that executes a correction operation to align the target point with the work point based on the control signal; wherein
the second operation frequency is a frequency less than or equal to ½ of the first and third operation frequencies.
